(19) United States
(12) Patent Application Publication
(10) Pub. No.: US 2025/0291346 A1
(43) Pub. Date: Sep. 18, 2025

(54) REMOTE OPERATION SYSTEM

(71) Applicant: TOYOTA JIDOSHA KABUSHIKI KAISHA, Toyota-shi (JP)

(72) Inventors: Emi SAKAOKA, Numazu-shi (JP); Go INOUE, Gotenba-shi (JP)

(73) Assignee: TOYOTA JIDOSHA KABUSHIKI KAISHA, Toyota-shi (JP)

(21) Appl. No.: 19/035,072

(22) Filed: Jan. 23, 2025

(30) Foreign Application Priority Data
Mar. 18, 2024 (JP) 2024-042155

(51) Int. Cl. G05D 1/224; G05D 1/226; H04W 24/02

(52) U.S. Cl. CPC G05D 1/2247; G05D 1/226; H04W 24/02

(57) ABSTRACT

A remote operation system is for a remote operation of a moving body performed by a remote operator. The remote operation system executes a delay compensation process that compensates for a communication delay between the moving body and a remote operator terminal. The delay compensation process includes a first delay compensation process and a second delay compensation process. The first delay compensation process is performed with respect to an image that is captured by a camera mounted on the moving body and is to be presented to the remote operator, thereby visually compensating for the communication delay. The second delay compensation process is performed with respect to remote operation information reflecting an amount of operation performed by the remote operator, and the moving body is controlled in accordance with the delay compensated operation information.

### CROSS-REFERENCES TO RELATED APPLICATION

The present disclosure claims priority to Japanese Patent Application No. 2024-042155, filed on Mar. 18, 2024, the contents of which application are incorporated herein by reference in their entirety.

### TECHNICAL FIELD

The present disclosure relates to a remote operation of a moving body performed by a remote operator.

### BACKGROUND ART

In a remote operation of a vehicle, an image (video) captured by an in-vehicle camera is transmitted from the vehicle to a remote operator terminal and is displayed on a display device of the remote operator terminal. Here, it is desired to compensate for a communication delay between the vehicle and the remote operator terminal.

Patent Literature 1 discloses a remote video output device. The remote video output device receives a video transmitted from an autonomous driving vehicle, and estimates a change in a position of a point of view of the autonomous driving vehicle according to a communication delay time. The remote video output device cuts out a partial range from a frame of the received video in consideration of the change in the position of the point of view of the autonomous driving vehicle, and displays the video of the cut-out range.

Non-Patent Literature 1 discloses a delay compensation technique using homography. More specifically, the delay compensation technique performs the homography on an image received from a vehicle in order to change a point of view according to an amount of movement of the vehicle corresponding to a delay time, thereby achieving the delay compensation. In other words, the delay compensation technique visually performs the delay compensation by predicting a camera image viewed from a future point of view that is ahead by the delay time.

### List of Related Art

Patent Literature 1: International Publication WO 2018/155159

Non-Patent Literature 1: Kodai Matsubara and Manabu Omae, “Compensation of Camera Image Latency in Remotely Operated Vehicle using Projection Transformation,” 19th ITS Symposium 2021,4-A-12, December 2021.

### SUMMARY

In a remote operation of a moving body, delay compensation may be performed on an image presented to a remote operator. For example, the delay compensation can be performed by the technique disclosed in Non-Patent Literature 1. However, when an amount of displacement of the vehicle increases, distortion of a transformed image obtained by the homography also increases. If the distortion of the transformed image is too large, it becomes difficult for the remote operator to grasp a situation around the moving body based on the transformed image.

An aspect of the present disclosure is directed to a remote operation system for a remote operation of a moving body performed by a remote operator.

The remote operation system includes one or more control devices configured to execute a delay compensation process that compensates for a communication delay between the moving body and a remote operator terminal on a side of the remote operator.

The delay compensation process includes:
a first delay compensation process that is performed with respect to an image captured by a camera mounted on the moving body; and
a second delay compensation process that is performed with respect to remote operation information reflecting an amount of operation performed by the remote operator.

The first delay compensation process includes:
acquiring a first image captured by the camera at a first timing;
generating a second image viewed from a point of view of the camera at a second timing by applying a homography process to the first image, the second timing being later than the first timing by a first delay compensation time; and
displaying the second image on a display of the remote operator terminal.

The second delay compensation process includes:
acquiring delay compensated operation information by performing delay compensation on the remote operation information for a second delay compensation time; and
controlling the moving body in accordance with the delay compensated operation information.

Combining the first delay compensation process and the second delay compensation process makes it possible to complement respective advantages/disadvantages of the first delay compensation process and the second delay compensation process. As a result, accuracy and stability of the delay compensation process as a whole are improved. This leads to improvement in accuracy and stability of the remote operation performed by the remote operator.

### BRIEF DESCRIPTION OF DRAWINGS

FIG. 1 is a schematic diagram showing an example of a configuration of a remote operation system;

FIG. 2 is a conceptual diagram for explaining an overview of a first delay compensation process;

FIG. 3 is a conceptual diagram for explaining homography based on perspective projection transformation;

FIG. 4 is a conceptual diagram for explaining an example of a second delay compensation process;

FIG. 5 shows a variety of examples of a combination of the first delay compensation process and the second delay compensation process; and

FIG. 6 shows various a variety of examples of a combinations of the first delay compensation process and the second delay compensation process.

### DETAILED DESCRIPTION

### 1. Overview of Remote Operation System

A remote operation (remote driving) of a moving body is considered. Examples of the moving body being a target of the remote operation include a vehicle, a robot, a flying object, and the like. The vehicle may be an autonomous driving vehicle or may be a vehicle driven by a driver. Examples of the robot include a logistic robot, a work robot, and the like. Examples of the flying object include a drone or the like. As an example, in the following description, a case where the moving body is a vehicle will be considered. When generalizing, “vehicle” in the following description shall be deemed to be replaced with “moving body.”

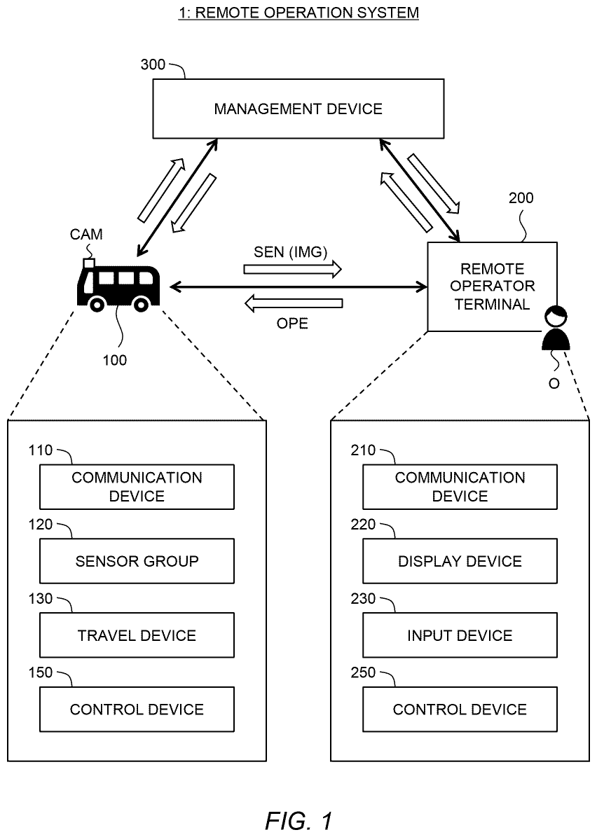

FIG. 1 is a schematic diagram showing a configuration example of a remote operation system 1 according to the present embodiment. The remote operation system 1 includes a vehicle 100, a remote operator terminal 200, and a management device 300. The vehicle 100 is the target of the remote operation. The remote operator terminal 200 is a terminal device used by a remote operator for the remote operation of the vehicle 100. The remote operator terminal 200 can also be referred to as a remote operation human machine interface (HMI). The management device 300 manages the remote operation system 1. Typically, the management device 300 is a management server on a cloud. The management server may be configured by a plurality of servers that perform distributed processing.

The vehicle 100, the remote operator terminal 200, and the management device 300 are capable of communicating with each other via a communication network. The vehicle 100 and the remote operator terminal 200 can communicate with each other via the management device 300. The vehicle 100 and the remote operator terminal 200 may directly communicate with each other without through the management device 300.

### 1-1. Configuration Example of Vehicle

The vehicle 100 includes a communication device 110, a sensor group 120, a travel device 130, and a control device 150.

The communication device 110 communicates with the remote operator terminal 200 and the management device 300.

The sensor group 120 includes a recognition sensor, a vehicle state sensor, a position sensor, and the like. The recognition sensor recognizes (detects) a situation around the vehicle 100. Examples of the recognition sensor include a camera CAM, a laser imaging detection and ranging (LIDAR), a radar, and the like. The vehicle state sensor detects a state of the vehicle 100. Examples of the vehicle state sensor include a speed sensor, an acceleration sensor, a yaw rate sensor, a steering angle sensor, and the like. The position sensor detects a position and a moving direction of the vehicle 100. For example, the position sensor includes a global navigation satellite system (GNSS) sensor.

The travel device 130 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device 150 is a computer that controls the vehicle 100. The control device 150 includes one or more processors and one or more memory devices. The processor executes a variety of processing. Examples of the processor include a central processing unit (CPU), a graphics processing unit (GPU), an application specific integrated circuit (ASIC), a field-programmable gate array (FPGA), and the like. The processor may also be referred to as “circuitry” or “processing circuitry.” The memory device stores a variety of information. Examples of the memory device 170 include a volatile memory, a nonvolatile memory, a hard disk drive (HDD), a solid state drive (SSD), and the like. The functions of the control device 150 may be realized by a cooperation of the processor executing a control program and the memory device. The control program is stored in the memory device. The control program may be recorded on a non-transitory computer-readable recording medium.

The control device 150 acquires sensor detection information SEN by using the sensor group 120. The sensor detection information SEN includes an image IMG, vehicle state information, position information, object information, and the like. The image IMG is captured by the camera CAM. The vehicle state information indicates a state (for example, a speed, a steering angle, or the like) of the vehicle 100 detected by the vehicle state sensor. The position information indicates the position and the moving direction of the vehicle 100 detected by the position sensor. The object information is information on an object (for example, a pedestrian, another vehicle, a road structure, a traffic light, a sign, and the like) around the vehicle 100. The control device 150 can recognize an object around the vehicle 100 by using the recognition sensor. The object information includes a relative position and a relative speed of the object with respect to the vehicle 100.

The control device 150 executes vehicle travel control that controls travel of the vehicle 100. The vehicle travel control includes steering control, driving control, and braking control. The control device 150 executes the vehicle travel control by controlling the travel device 130 (i.e., the steering device, the driving device, and the braking device).

The control device 150 may execute autonomous driving control based on the sensor detection information SEN. More specifically, the control device 150 generates a travel plan of the vehicle 100 based on the sensor detection information SEN. Further, the control device 150 generates a target trajectory required for the vehicle 100 to travel in accordance with the travel plan, based on the sensor detection information SEN. The target trajectory includes a target position and a target velocity. Then, the control device 150 executes the vehicle travel control such that the vehicle 100 follows the target trajectory.

During the remote operation of the vehicle 100, the control device 150 communicates with the remote operator terminal 200 via the communication device 110. The control device 150 transmits at least a part of the sensor detection information SEN to the remote operator terminal 200. The sensor detection information SEN transmitted to the remote operator terminal 200 includes at least the image IMG captured by the camera CAM. Moreover, the control device 150 receives remote operation information OPE (described later) from the remote operator terminal 200. The remote operation information OPE is information reflecting an amount of operation performed by the remote operator O. The control device 150 performs the vehicle travel control in accordance with the received remote operation information OPE.

### 1-2. Configuration Example of Remote Operator Terminal

The remote operator terminal 200 includes a communication device 210, a display device 220, an input device 230, and a control device 250.

The communication device 210 communicates with the vehicle 100 and the management device 300.

The display device 220 displays a variety of information for the remote operator O who performs the remote operation. In other words, the display device 220 presents a variety of information to the remote operator O by displaying the variety of information. Examples of the display device 220 include a display and a touch panel.

The input device 230 is a member operated by the remote operator O when remotely operating the vehicle 100. For example, the input device 230 includes a remote operation member. The remote operation member includes a steering wheel, an accelerator pedal, a brake pedal, a direction indicator, and the like.

The control device 250 is a computer that controls the remote operator terminal 200. The control device 250 includes one or more processors and one or more memory devices. The processor executes a variety of processing. Examples of the processor include a CPU, a GPU, an ASIC, FPGA, and the like. The processor may also be referred to as “circuitry” or “processing circuitry.” The memory device stores a variety of information. Examples of the memory device include a volatile memory, a nonvolatile memory, an HDD, an SSD, and the like. The functions of the control device 250 may be realized by a cooperation of the processor executing a control program and the memory device. The control program is stored in the memory device. The control program may be recorded on a non-transitory computer-readable recording medium.

During the remote operation of the vehicle 100, the control device 250 communicates with the vehicle 100 via the communication device 210. The control device 250 receives the sensor detection information SEN transmitted from the vehicle 100. The control device 250 presents necessary information included in the received sensor detection information SEN to the remote operator O. For example, the control device 250 presents the image IMG to the remote operator O by displaying the image IMG on the display device 220. The remote operator O is able to recognize the state of the vehicle 100 and the surrounding situation based on the presented information.

The remote operator O operates the input device 230. The amount of operation of the input device 230 is detected by a sensor installed in the input device 230. The control device 250 generates the remote operation information OPE reflecting the amount of operation of the input device 230 performed by the remote operator O. The amount of operation includes at least one of a steering operation amount, an accelerator operation amount, and a brake operation amount. Then, the control device 250 transmits the remote operation information OPE to the vehicle 100 via the communication device 210. In this manner, the remote operation of the vehicle 100 is realized.

### 2. Delay Compensation Process

The remote operation of the vehicle 100 is accompanied by a communication delay between the vehicle 100 and the remote operator terminal 200. The communication delay may destabilize a behavior of the vehicle 100 during the remote operation. In addition, the communication delay may cause a decrease in accuracy of the remote operation of the vehicle 100. Therefore, it is important to execute a “delay compensation process” that compensates for the communication delay during the remote operation of the vehicle 100.

In the present embodiment, two types of delay compensation processes will be considered. A “first delay compensation process” is the delay compensation process performed with respect to the image IMG presented to the remote operator O. On the other hand, a “second delay compensation process” is the delay compensation process performed with respect to the remote operation information OPE reflecting the amount of operation performed by the remote operator O. The first delay compensation process and the second delay compensation process will be described below.

### 2-1. First Delay Compensation Process

In the first delay compensation process, the remote operation system 1 visually performs the delay compensation on the image IMG displayed on the display device 220 in consideration of the communication delay. In particular, the remote operation system 1 according to the present embodiment visually performs the delay compensation on the image IMG by using “homography”.

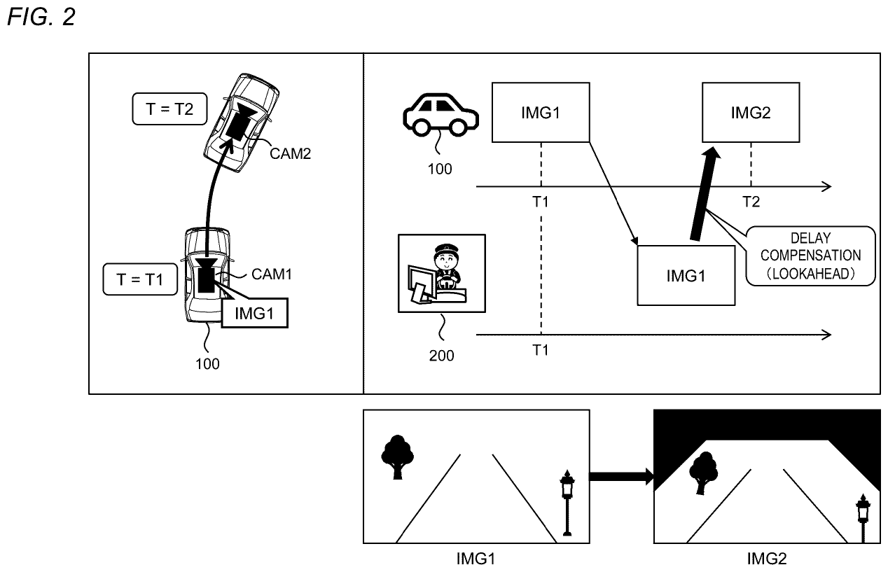

FIG. 2 is a conceptual diagram for explaining an overview of the first delay compensation process performed by the remote operation system 1. A first image IMG1 is the image IMG actually captured at a first timing TI by the camera CAM mounted on the vehicle 100. The first image IMG1 is transmitted from the vehicle 100 to the remote operator terminal 200. The remote operator terminal 200 acquires the first image IMG1 after the first timing T1. If an image IMG that will be captured in the future can be predicted from the first image IMG1 (i.e., if lookahead is possible), it is possible to perform the delay compensation.

A second timing T2, which is a target timing of the lookahead (predicting), is a timing later than the first timing T1. A difference between the second timing T2 and the first timing T1 corresponds to a “delay compensation time”. The remote operation system 1 may set at least a part of a round-trip communication delay time between the vehicle 100 and the remote operator terminal 200 as the delay compensation time. The communication delay time between the vehicle 100 and the remote operator terminal 200 can be estimated by a publicly known technique. The delay compensation time may be set to the round-trip communication delay time between the vehicle 100 and the remote operator terminal 200. The delay compensation time may be set to a communication time from when the image IMG is transmitted from the vehicle 100 to when the image IMG reaches the remote operator terminal 200. Alternatively, the delay compensation time may be set to a constant value. In either case, the remote operation system 1 sets the second timing T2 to be later than the first timing T1 by the delay compensation time.

For convenience, the camera CAM at the first timing T1 is referred to as a first camera CAM1, and the camera CAM at the second timing T2 is referred to as a second camera CAM2. A first point of view, which is a point of view of the first camera CAM1, is defined by a combination of a position and a viewing direction of the first camera CAM1 at the first timing T1. A second point of view, which is a point of view of the second camera CAM2, is defined by a combination of a predicted position and a predicted viewing direction of the second camera CAM2 at the second timing T2.

The remote operation system 1 acquires camera information CINF regarding the camera CAM mounted on the vehicle 100. The camera information CINF includes installation information and performance information of the camera CAM. The installation information indicates an installation position and an installation direction of the camera CAM in a vehicle coordinate system. The performance information indicates a focal length, an angle of view, and the like of the camera CAM. Since the camera CAM is fixed to the vehicle 100, using the installation information of the camera CAM makes it possible to convert a direction and an amount of movement of the vehicle 100 into a direction and an amount of movement of the camera CAM in a camera coordinate system. In other words, it is possible to estimate a change in the point of view of the camera CAM based on the installation information of the camera CAM and the direction and the amount of movement of the vehicle 100.

More specifically, the remote operation system 1 estimates the direction and the amount of movement of the vehicle 100 in the period from the first timing T1 to the second timing T2 (that is, the delay compensation time). For example, the remote operation system 1 estimates the direction and the amount of movement of the vehicle 100 in the period from the first timing T1 to the second timing T2 based on a speed and a steering angle of the vehicle 100 at the first timing T1 and the delay compensation time. The information of the speed and steering angle of the vehicle 100 is obtained from the sensor detection information SEN provided from the vehicle 100. Alternatively, a steering angle in a steering operation performed by the remote operator O may be regarded as the steering angle of the vehicle 100. It may be assumed that the vehicle 100 makes a steady circular turn. Then, the remote operation system 1 calculates the difference between the first point of view and the second point of view based on the above-mentioned camera information CINF (installation information) and the amount and the direction of movement of the vehicle 100 in the delay compensation time.

It can be said that the first image IMG1 is the image IMG taken from the first point of view, that is, the image IMG viewed from the first point of view. The image IMG expected to be taken from the second point of view, that is, the image IMG expected to be viewed from the second point of view is hereinafter referred to as a “second image IMG2”. The remote operation system 1 converts the first image IMG1 viewed from the first point of view into the second image IMG2 viewed from the second point of view based on the difference between the first point of view and the second point of view. In other words, the remote operation system 1 predicts (prefetches) the second image IMG2 viewed from the second point of view, based on the first image IMG1 viewed from the first point of view. Homography is used for the predicting (i.e., lookahead).

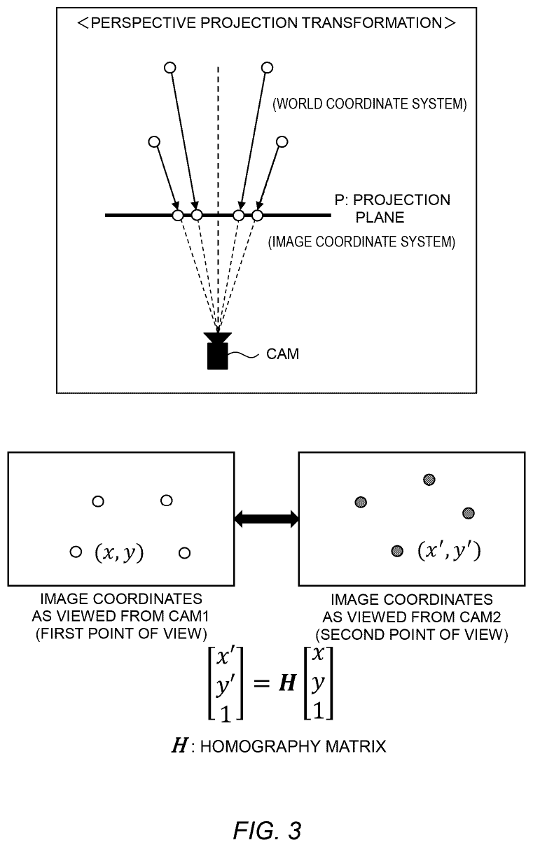

FIG. 3 is a conceptual diagram for explaining the homography. The homography is performed based on perspective projection transformation. The perspective projection transformation is a rendering technique for drawing an object present in a three dimensional space on a two dimensional plane as viewed from the camera CAM. To that end, the perspective projection transformation projects points in the three dimensional space onto a projection plane P in consideration of the point of view of the camera CAM. The projection plane P is associated with the camera CAM. For example, the projection plane P is a plane orthogonal to an optical axis of the camera CAM. It should be noted that a point in the three dimensional space is defined in a three dimensional world coordinate system (i.e., the absolute coordinate system). On the other hand, the point projected on the projection plane P is defined in a two dimensional image coordinate system.

For example, N virtual points are virtually set in the three dimensional world coordinate system. Here, N is an integer of 4 or more. The N virtual points as viewed from the first camera CAM1 (i.e., the first point of view) are projected onto a first projection plane P1 associated with the first camera CAM1 by the perspective projection transformation. Further, the N virtual points viewed from the second camera CAM2 (i.e., the second point of view) are projected onto a second projection plane P2 associated with the second camera CAM2 by the perspective projection transformation. The second point of view can be obtained from the difference between the first point of view and the second point of view. Image coordinates of the virtual points on the first projection plane P1 as viewed from the first camera CAM1 (i.e., the first point of view) are given by [x, y]. On the other hand, image coordinates of the virtual points on the second projection plane P2 as viewed from the second camera CAM2 (i.e., the second point of view) are given by [x′, y′]. Based on a comparison between the two kinds of image coordinates, a homography matrix H for transforming from the first point of view to the second point of view is calculated. Then, the homography matrix H is applied to the entire first image IMG1 actually taken by the first camera CAM1, and thereby the second image IMG2 expected to be viewed from the second point of view is generated.

As another example, the method described in the above-mentioned Non-Patent Literature 1 may be used. More specifically, each image coordinate point on the first image IMG1 (projection plane P) is transformed into a world coordinate point in the world coordinate system by inverse transformation of the perspective projection transformation. Then, the world coordinate point as viewed from the first point of view is converted into a world coordinate point as viewed from the second point of view, based on the difference between the first point of view and the second point of view. Then, the world coordinate point as viewed from the second point of view is re-projected onto the projection plane P by the perspective projection transformation. As a result, the second image IMG2 that is expected to be viewed from the second point of view is generated.

The entity of the first delay compensation process is, for example, the remote operator terminal 200. However, the entity of the first delay compensation process is not limited to the remote operator terminal 200. At least a part of the first delay compensation process may be executed by the vehicle 100 or the management device 300. In either case, the remote operator station 200 finally acquires the second image IMG2. Then, the remote operator terminal 200 displays the second image IMG2 on the display device 220. As a result, the communication delay is visually compensated for.

### 2-2. Second Delay Compensation Process

The remote operation information OPE, which is information reflecting the amount of remote operation performed by the remote operator O, is transmitted from the remote operator terminal 200 to the vehicle 100. The vehicle 100 receives the remote operation information OPE at least the communication delay after a timing of the remote operation performed by the remote operator O. If the delay compensation is not performed, the amount of remote operation performed by the remote operator O is reflected in a behavior of the vehicle 100 after the communication delay time or more from the timing of the remote operation.

In view of the above, in the second delay compensation process, the remote operation system 1 performs the delay compensation with respect to the remote operation information OPE in consideration of the communication delay. More specifically, the remote operation system 1 corrects the remote operation information OPE so that a time required for the amount of remote operation performed by the remote operator O to be reflected in the behavior of the vehicle 100 is shortened. The remote operation information OPE subjected to such the second delay compensation process is hereinafter referred to as delay compensated operation information OPE' for convenience. That is, the remote operation system 1 acquires the delay compensated operation information OPE' by performing delay compensation on the remote operation information OPE for a delay compensation time. The delay compensation time may be set to at least a part of the round-trip communication delay time between the vehicle 100 and the remote operator terminal 200. The communication delay time between the vehicle 100 and the remote operator terminal 200 can be estimated by a publicly-known technique. Alternatively, the delay compensation time may be set to a constant value. Then, the remote operation system 1 controls the vehicle 100 in accordance with the delay compensated operation information OPE' obtained by the second delay compensation process.

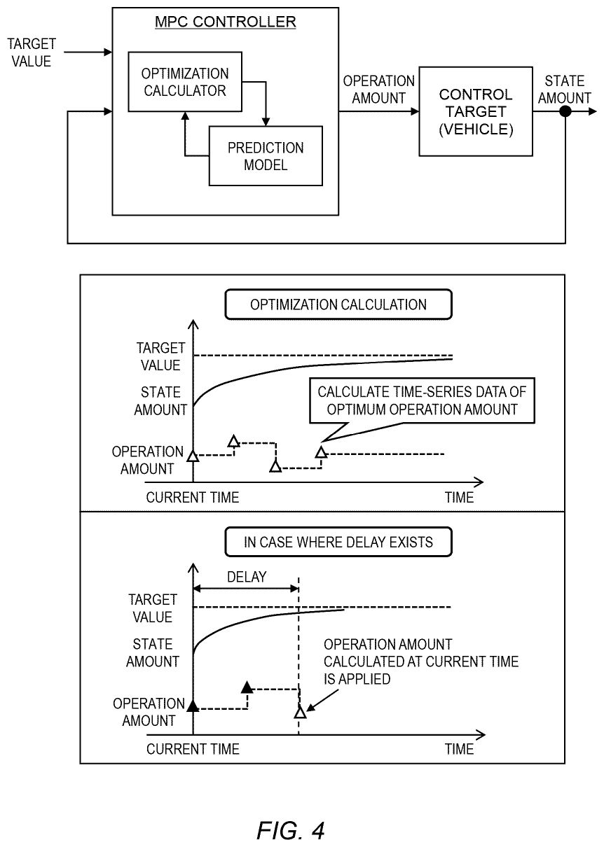

FIG. 4 is a conceptual diagram for explaining an example of the second delay compensation process. In the present example, the remote operation information OPE is corrected by using model predictive control (MPC). First, a target value representing a target vehicle behavior aimed by the remote operator O is calculated from the remote operation information OPE reflecting the amount of remote operation performed by the remote operator O. An MPC controller receives the target value. In addition, the MPC controller receives a state amount (output) indicating an actual vehicle behavior of the vehicle 100 being is a control target. The MPC controller includes an optimization calculator and a prediction model. The prediction model is a model of the vehicle 100 being the control target, and includes, for example, an equation of motion of the vehicle 100. The MPC controller calculates an optimum operation amount for the state amount to follow the target value, through prediction using the prediction model and optimization by the optimization calculator. In particular, according to the present embodiment, the MPC controller calculates an optimum operation amount for the state amount to follow the target value, in consideration of the delay in the vehicle behavior of the delay compensation time. The delay compensated operation information OPE' indicates the optimum operation amount thus calculated. Then, the vehicle 100 is controlled in accordance with the delay compensated operation information OPE'.

It should be noted that that entity of the second delay compensation process may be the remote operator terminal 200 or may be the vehicle 100. That is, the MPC controller may be included in the remote operator terminal 200 or may be included in the vehicle 100.

For example, the remote operator terminal 200 includes the MPC controller and performs the second delay compensation process. In this case, the remote operator terminal 200 acquires the remote operation information OPE and acquires the delay compensated operation information OPE′ by performing the second delay compensation process on the remote operation information OPE. The remote operator terminal 200 transmits the delay compensated operation information OPE′ to the vehicle 100. The vehicle 100 receives the delay compensated operation information OPE′ from the remote operator terminal 200 and performs the vehicle control in accordance with the delay compensated operation information OPE′.

As another example, the vehicle 100 includes the MPC controller and performs the second delay compensation process. In this case, the remote operator terminal 200 transmits the remote operation information OPE to the vehicle 100. The vehicle 100 receives the remote operation information OPE from the remote operator terminal 200, and acquires the delay compensated operation information OPE′ by performing the second delay compensation process on the remote operation information OPE. Then, the vehicle 100 performs the vehicle control in accordance with the delay compensated operation information OPE′.

### 3. Combination of Delay Compensation Processes

### 3-1. Overview

As described above, the first delay compensation process performs the delay compensation with respect to the first image IMG1 based on the homography process. One of the characteristics of the homography process is as follows: when the amount of displacement of the vehicle 100 increases, the amount of transformation from the first point of view to the second point of view also increases, and thus distortion of the second image IMG2 displayed on the display device 220 tends to increase. For example, the distortion of the second image IMG2 increases with an increase in the steering angle of the steering operation performed by the remote operator O. As another example, the distortion of the second image IMG2 increases with an increase in the speed of the vehicle 100. If the distortion of the second image IMG2 is too large, it becomes difficult for the remote operator O to grasp a situation around the vehicle 100 based on the second image IMG2.

On the other hand, the second delay compensation process is performed with respect to the remote operation information OPE. When the remote operation information OPE changes very quickly, followability of the second delay compensation process deteriorates. For example, in a case of slalom traveling, a steering frequency is high, and the followability of the second delay compensation process in that case is not necessarily high. The deterioration of the followability of the second delay compensation process (e.g., steering delay) causes a decrease in the accuracy of the delay compensated operation information OPE'.

As described above, the first delay compensation process and the second delay compensation process have their respective advantages and disadvantages. The first delay compensation process using the homography process is not necessarily appropriate in a situation where the distortion of the second image IMG2 becomes very large (e.g., large steering angle, high vehicle speed). On the other hand, the second delay compensation process is able to accurately calculate the delay compensated operation information OPE′ even in such the situation as the large steering angle and the high vehicle speed. However, the second delay compensation process is not necessarily appropriate in a situation of high steering frequency in which the followability deteriorates. On the other hand, in the situation of high steering frequency, the distortion of the second image IMG2 does not become large, and thus the first delay compensation process is appropriate.

From the above-described insights, the remote operation system 1 according to the present embodiment performs the delay compensation process by combining the first delay compensation process and the second delay compensation process. Combining the first delay compensation process and the second delay compensation process makes it possible to complement respective advantages/disadvantages of the first delay compensation process and the second delay compensation process. As a result, accuracy and stability of the delay compensation process as a whole are improved. This leads to improvement in accuracy and stability of the remote operation performed by the remote operator O.

It should be noted that the first delay compensation process and the second delay compensation process may be executed by the same entity or may be separately executed by different entities. For example, both the first delay compensation process and the second delay compensation process may be executed by the remote operator terminal 200. As another example, the first delay compensation process may be executed by the remote operator terminal 200, and the second delay compensation process may be executed by the vehicle 100. When generalizing, the first delay compensation process and the second delay compensation process are executed by one or more control device (150, 250, or 150 and 250). It can also be said that the first delay compensation process and the second delay compensation process are executed by processing circuitry.

### 3-2. Various Examples

The delay compensation time in the first delay compensation process is hereinafter referred to as a “first delay compensation time”. On the other hand, the delay compensation time in the second delay compensation process is hereinafter referred to as a “second delay compensation time”. A sum of the first delay compensation time and the second delay compensation time is a “total delay compensation time”. The total delay compensation time may be set to at least a part of the round-trip communication delay time between the vehicle 100 and the remote operator terminal 200. The total delay compensation time may be set to the round-trip communication delay time between the vehicle 100 and the remote operator terminal 200. The round-trip communication delay time can be estimated by a publicly-known technique. Alternatively, the total delay compensation time may be set to a constant value.

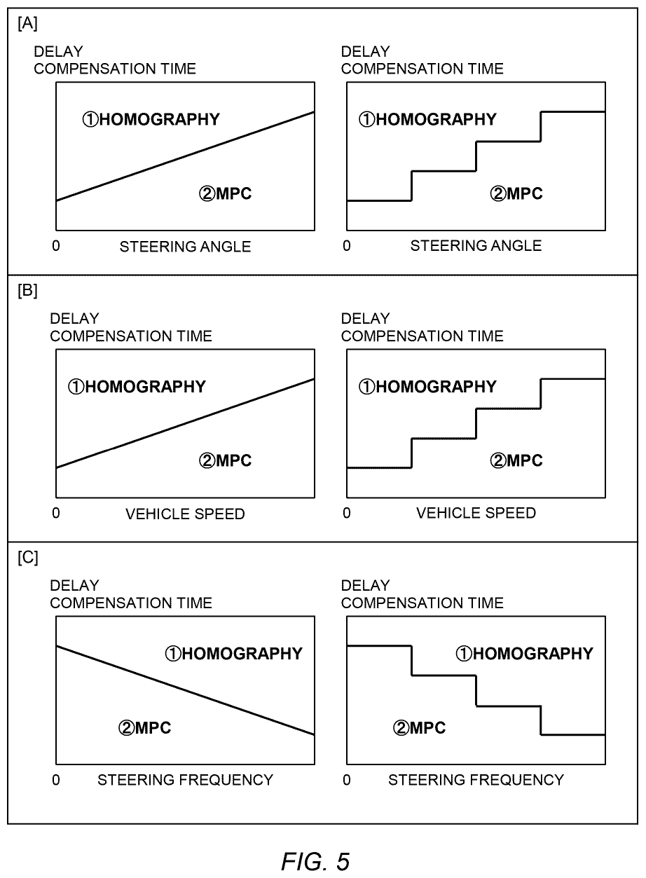

FIG. 5 is a conceptual diagram showing various examples of combinations of the first delay compensation process and the second delay compensation process. In FIG. 5, a vertical axis represents the delay compensation time, and a horizontal axis represents various parameters. Further, “homography” means the first delay compensation process, and “MPC” means the second delay compensation process. In the example illustrated in FIG. 5, a ratio between the first delay compensation time and the second delay compensation time is dynamically changed according to the parameter. More specifically, the first delay compensation time and the second delay compensation time are set such that the second delay compensation time increases as the first delay compensation time decreases. In other words, the first delay compensation time and the second delay compensation time are set such that the second delay compensation time decreases as the first delay compensation time increases.

A part [A] in FIG. 5 shows a case where the parameter is the steering angle of the steering operation performed by the remote operator O. The steering angle is obtained from the remote operation information OPE. As the steering angle increases, the first delay compensation time decreases and the second delay compensation time increases (first process). The change (decrease or increase) in each delay compensation time may be a monotonous change or a stepwise change. Since the first delay compensation time decreases with an increase in the steering angle, the distortion of the second image IMG2 is suppressed. Therefore, the remote operator O is able to favorably grasp the situation around the vehicle 100 based on the second image IMG2.

A part [B] in FIG. 5 shows a case where the parameter is the speed of the vehicle 100. The speed of the vehicle 100 is obtained from the sensor detection information SEN. As the speed increases, the first delay compensation time decreases and the second delay compensation time increases (second process). The change (decrease or increase) in each delay compensation time may be a monotonous change or a stepwise change. Since the first delay compensation time decreases with an increase in the speed, the distortion of the second image IMG2 is suppressed. Therefore, the remote operator O is able to favorably grasp the situation around the vehicle 100 based on the second image IMG2.

A part [C] in FIG. 5 shows a case where the parameter is the steering frequency of the steering operation performed by the remote operator O. The steering frequency is obtained from the remote operation information OPE. As the steering frequency increases, the second delay compensation time decreases and the first delay compensation time increases (third process). The change (decrease or increase) in each delay compensation time may be a monotonous change or a stepwise change. Since the second delay compensation time decreases with an increase in the steering frequency, deterioration in the followability (steering delay) is suppressed.

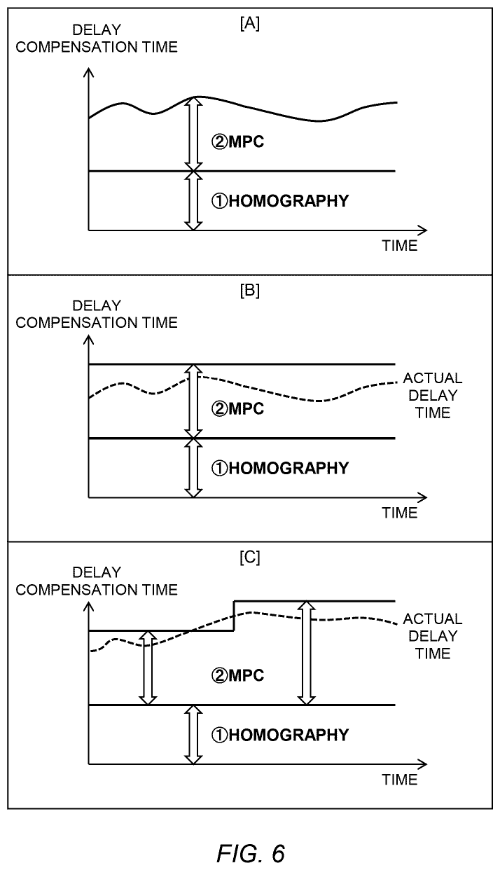

FIG. 6 is a conceptual diagram showing further various examples of combinations of the first delay compensation process and the second delay compensation process. In FIG. 6, a vertical axis represents the delay compensation time, and a horizontal axis represents time. In the example illustrated in FIG. 6, at least one of the first delay compensation time and the second delay compensation time is fixed.

A part [A] in FIG. 6 shows a case where the first delay compensation time is fixed to a first constant value and the second delay compensation time is not fixed. When the first delay compensation time in the first delay compensation process (i.e., the homography process) frequently changes, “flickering” of the second image IMG2 may occur. By fixing the first delay compensation time, it is possible to prevent such the “flickering” from occurring. The second delay compensation time may vary depending on the actual communication delay time (e.g., the actual round-trip communication delay time). For example, the second delay compensation time may be set to a difference between the actual communication delay time and the first delay compensation time (i.e., the first constant value).

As a modification, it is also possible that the second delay compensation time is fixed to a second constant value and the first delay compensation time is not fixed. When the second delay compensation time in the second delay compensation process changes frequently, arithmetic processing may become heavy. By fixing the second delay compensation time, the load of the arithmetic processing can be reduced. The first delay compensation time may vary depending on the actual communication delay time (e.g., the actual round-trip communication delay time). For example, the first delay compensation time may be set to a difference between the actual communication delay time and the second delay compensation time (i.e., second constant value).

A part [B] in FIG. 6 shows a case where the first delay compensation time is fixed to a first constant value and the second delay compensation time is fixed to a second constant value. The total delay compensation time, which is the sum of the first delay compensation time and the second delay compensation time, may be set with a margin so as to be longer than a usual communication delay time.

A part [C] in FIG. 6 shows a modification example of the above part [B]. Here, a plurality of patterns are prepared as the total delay compensation time. The total delay compensation time is switched among the plurality of patterns in conjunction with the actual communication delay time. For example, one of the plurality of patterns that is longer than the actual communication delay time and is the minimum is preferentially selected. When the actual communication delay time exceeds the total delay compensation time for a certain period, the total delay compensation time is switched to a new pattern.

What is claimed is:

1. A remote operation system for a remote operation of a moving body performed by a remote operator,
the remote operation system comprising processing circuitry configured to execute a delay compensation process that compensates for a communication delay between the moving body and a remote operator terminal on a side of the remote operator, wherein
the delay compensation process includes:
a first delay compensation process that is performed with respect to an image captured by a camera mounted on the moving body; and
a second delay compensation process that is performed with respect to remote operation information reflecting an amount of operation performed by the remote operator,
the first delay compensation process includes:
acquiring a first image captured by the camera at a first timing;
generating a second image viewed from a point of view of the camera at a second timing by applying a homography process to the first image, the second timing being later than the first timing by a first delay compensation time; and
displaying the second image on a display of the remote operator terminal, and
the second delay compensation process includes:
acquiring delay compensated operation information by performing delay compensation on the remote operation information for a second delay compensation time; and
controlling the moving body in accordance with the delay compensated operation information.

2. The remote operation system according to claim 1, wherein
the processing circuitry is further configured to dynamically change a ratio between the first delay compensation time and the second delay compensation time.

3. The remote operation system according to claim 2, wherein
the processing circuitry is further configured to set the first delay compensation time and the second delay compensation time such that the second delay compensation time increases as the first delay compensation time decreases.

4. The remote operation system according to claim 2, wherein
the processing circuitry is further configured to execute at least one of:
a first process that decreases the first delay compensation time and increases the second delay compensation time with an increase in a steering angle of a steering operation performed by the remote operator;
a second process that decreases the first delay compensation time and increases the second delay compensation time with an increase in a speed of the moving body; and
a third process that increases the first delay compensation time and decreases the second delay compensation time with an increase in a steering frequency of a steering operation performed by the remote operator.

5. The remote operation system according to claim 1, wherein
the processing circuitry is further configured to fix at least one of the first delay compensation time and the second delay compensation time.
